(19) United States
(12) Patent Application Publication
(10) Pub. No.: US 2020/0107077 A1
(43) Pub. Date: Apr. 2, 2020

(54) SYSTEM AND METHOD FOR BLENDED CONTENT SEARCHES ACROSS DISPARATE SOURCES

(71) Applicant: Caavo Inc, Milpitas, CA (US)

(72) Inventors: Andrew E. Einaudi, San Francisco, CA (US); Boone Spooner, Mill Valley, CA (US); Ashish D. Aggarwal, Stevenson Ranch, CA (US)

(21) Appl. No.: 16/588,758

(22) Filed: Sep. 30, 2019

Related U.S. Application Data
(60) Provisional application No. 62/739,266, filed on Sep. 30, 2018.

(51) Int. Cl. H04N 21/482; G06F 16/738; H04N 21/472; H04N 21/4363; G06F 16/783; G06F 16/735

(52) U.S. Cl. CPC H04N 21/4826; G06F 16/738; G06F 16/735; H04N 21/43635; G06F 16/7844; H04N 21/47202

(57) ABSTRACT

Methods for blended content searches across disparate sources and display of results in a user interface are performed by systems, devices, and apparatuses. Blended searches and results provide for a search and result delivery mechanism to enable users to find content they are looking for across multiple and/or disparate sources. Content that is searched is located spread across different, unrelated services/sources that have exclusive access for searching the content, or live television, on different multimedia devices, as well as on local devices in the form of recordings and locally stored libraries. The blended content searches performed allow for results obtained across disparate sources to be returned to a user from a single search and provided to a single user interface in a common format. Search results are displayed based on rankings and categories associated with the content and content sources.

### CROSS-REFERENCE TO RELATED APPLICATION(S)

The instant application claims priority to U.S. Provisional Application No. 62/739,266 (Atty. Docket No. H16.00500000), entitled “SYSTEM AND METHOD FOR BLENDED CONTENT SEARCHES ACROSS DISPARATE SOURCES,” and filed on Sep. 30, 2018, the entirety of which is incorporated by reference herein.

### BACKGROUND

### I. Technical Field

Embodiments described herein relate to blended content searches.

### II. Background Art

Current solutions for content searches return results from a single type of content source based on the origin of the search and the specific body of information that is searched. A search for content such as multimedia content, like a television show or a movie, via the Internet using a browser returns results from Internet-based sources to the browser at a user device. A search for content in user interface of a guide for a television programming provider returns results of channels as provided by the provider in the user interface.

### BRIEF SUMMARY

Methods, systems, and apparatuses are described for blended content searches across disparate sources, substantially as shown in and/or described herein in connection with at least one of the figures, as set forth more completely in the claims. Blended searches and results as described herein provide for searches and resulting deliveries that enable users to find content they are looking for across disparate sources. Content is often spread across different services/sources that have exclusive access for searching the content, or live TV, on different multimedia devices, and even on local devices in the form of recordings and locally stored libraries, and the blended content searches allow for results obtained across disparate sources to be returned to a user from a single search and provided to a single user interface in a common format. Search results are displayed based on rankings and/or categories associated with the content and content sources.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a networked system for blended content searches across disparate sources, according to an example embodiment.

FIG. 2 shows a block diagram of a blended search host system for blended content searches across disparate sources, according to an example embodiment.

FIG. 3 shows a flowchart for blended content searches across disparate sources, according to an example embodiment.

FIG. 4 shows a block diagram of a switch system for blended content searches across disparate sources, according to an example embodiment.

FIG. 5 show user interfaces for blended content searches across disparate sources, according to an example embodiment.

FIG. 6 shows a user interface for blended content searches across disparate sources, according to an example embodiment.

FIG. 7 shows a user interface for blended content searches across disparate sources, according to an example embodiment.

FIG. 8 shows a user interface for blended content searches across disparate sources, according to an example embodiment.

FIG. 9 shows a user interface for blended content searches across disparate sources, according to an example embodiment.

FIG. 10 shows a block diagram of a mobile device/system in which the techniques disclosed herein may be performed and the embodiments herein may be utilized.

FIG. 11 shows a block diagram of a computing device/system in which the techniques disclosed herein may be performed and the embodiments herein may be utilized.

Embodiments will now be described with reference to the accompanying drawings.

In the drawings, like reference numbers indicate identical or functionally similar elements. Additionally, the left-most digit(s) of a reference number identifies the drawing in which the reference number first appears.

### DETAILED DESCRIPTION

### I. INTRODUCTION

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives such as “substantially,” “approximately,” and “about” modifying a condition or relationship characteristic of a feature or features of an embodiment of the disclosure, are understood to mean that the condition or characteristic is defined to be within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Still further, it should be noted that the drawings/figures are not drawn to scale unless otherwise noted herein.

Applicant(s) expressly disclaim any rights to any third-party trademarks and/or copyrighted images included in the figures or written description. Such marks and/or images have been included for illustrative purposes only and constitute the sole property of their respective owners.

Numerous exemplary embodiments are now described. Any section/subsection headings provided herein are not intended to be limiting. Embodiments are described throughout this document, and any type of embodiment may be included under any section/subsection. Furthermore, it is contemplated that the disclosed embodiments may be combined with each other in any manner. That is, the embodiments described herein are not mutually exclusive of each other and may be practiced and/or implemented alone, or in any combination.

### II. EXAMPLE EMBODIMENTS

Blended searches and results as described herein provide a search and result delivery mechanism to enable users to find content they are looking for across disparate sources. That is, content is often spread across different services/sources that have exclusive access for searching the content, or live TV, on different multimedia devices, and even on local devices in the form of recordings and locally stored libraries. The blended content searches described herein allow for results to be obtained across multiple, disparate sources and returned to a user based on a single search. Results are provided to a single user interface in a common format. Search results may be displayed based on rankings and/or categories associated with the content and content sources.

The example techniques and embodiments described herein may be adapted to various types of systems and devices, for example but without limitation, communication devices (e.g., cellular and smart phones, etc.), computers/computing devices (e.g., laptops, tablets, desktops, etc.), computing systems, electronic devices, gaming consoles, home electronics and entertainment devices (e.g., home theater systems, stereos, televisions (TVs), media players, set top boxes (STBs), digital video recorders (DVRs), digital-versatile disc (DVD) players, etc.), high-definition multimedia interface (HDMI) switches, repeaters, and/or the like. It is contemplated herein that in various embodiments and with respect to the illustrated figures of this disclosure, one or more components described and/or shown may not be included and that additional components may be included.

The embodiments and techniques described herein provide for blended searches across disparate content sources. For example, blended searching may be performed by search hosts and media devices from Caavo Inc of Milpitas, Calif. While described in the context of video, media, and multimedia content, the blended searches and results described herein are applicable to, and provide users with the ability to, find content from a diverse, disparate set of content sources. In the context of video, media, and multimedia content, content sources may include, without limitation, live TV, streaming TV (such as via Roku®, Netflix®, Hulu®, etc.), a local DVR, a local computer, a local smartphone, curated content such as from a Plex Media Server®, user/editorial content lists (e.g., playlists, favorites, content histories such as viewing, watch, listening, and/or the like, editor curated lists, etc.), YouTube®, iTunes®, music services (e.g., Spotify®, Pandora®, Apple Music®, etc.), other media and multimedia devices, and/or the like, where the content sources are connected to, or are accessible via, the user system. Users are thus provided with ways, e.g., specifically configured user interfaces (UIs), for easily viewing the top search results from these content sources on a UI displayed on their TV, and then for selecting and watching items from those blended search results. The embodiments herein also provide for searches across connected devices (i.e., relay searching) where a user can pass the search query to a connected device.

Blended searches as described herein provide for search results that include content from different, disparate content sources, at a single device such as a television of a home entertainment system (e.g., in a 10 foot media experience) or via a personal device (e.g., in a 2 foot media experience). That is, the embodiments herein provide for a centrally-located interface that displays simplified, standardized, actionable search results from different, unrelated sources for viewing content. In other words, cross-sourcing of content for searches is enabled herein, including web-based content, live content, streaming service content, locally stored content, etc. An audio/video repeater and/or an HDMI switch may be configured to operate as the central device in a 10 foot experience, and may be utilized with or in lieu of a search host with a blended search service that sits atop the systems of disparate content sources.

A user is enabled to interact with the systems and devices for blended searches described herein in various ways. By way of example and not limitation, a user may activate a microphone (e.g., of their remote controller or otherwise) and say the term(s) that they wish to query/search, or a user may navigate to a search page UI of a multimedia device such as an HDMI switch as described herein, and then type the item that they wish to search. The query/search may be received by the switch and/or by a blended search host which implements search engines. The results are found, ranked, and returned for provision to a Search Page UI based on rank and content source. Here the user can peruse a Top Results lists of blended results and select any result that they think most closely matches that which they searched for.

If a user does not find the content within the Top Results, they can then navigate to select a specific category or content source filter through which they would like to find more results. The user can also select an option to see more results of content sources listed in the Top Results to automatically jump to the related section and see all related content results. In the filter/category view, the UI may present the user with paginated results on which the user can page down to view more results until the search server does not have any more to display.

In other words, users do not have to search separately for content, multiple times, over different content sources, according to the described embodiments.

It should also be noted that while various embodiments herein may be described with respect to HDMI switches for purposes of illustration and explanation, such embodiments are not so limited and audio/video repeaters or the like of different types, designs, protocols, etc., as well as other types of systems are contemplated in accordance with embodiments.

FIG. 1 will now be described. An example networked system 100 (“system 100” hereinafter) is shown in FIG. 1, according to an embodiment. System 100 may be configured for blended content searches across disparate sources. System 100 includes a client device 102, a blended search host 104, and HDMI switch 106, and additional content sources 116 which may be configured to communicate over a network 110. One or more HDMI devices 118 (e.g., source and/or sink devices) may be connected via HDMI cables/connections to HDMI switch 106. It should be noted that any numbers of client devices, blended search hosts, additional content sources, HDMI switches, and/or HDMI devices may be present in various embodiments, and that the configuration in FIG. 1 is non-limiting and shown for brevity and illustrative clarity. Additionally, any combination of the components illustrated in FIG. 1 may be present in system 100, according to embodiments.

Network 110 may comprise any type of communication links that connect computing devices and servers such as, but not limited to, the Internet, wired or wireless networks and portions thereof, point-to-point connections, local area networks, enterprise networks, virtual private networks (VPNs), and/or the like.

Client device 102 may be any type of computing device or computing system, including without limitation, a terminal, a personal computer, a laptop computer, a tablet device, a smart phone, a game console, a server(s) (distributed or otherwise), etc., that may be used by users to interact with HDMI switch 106 and/or blended search host 104 as described below, such as with user interfaces (UIs) described herein, e.g., as described for UI(s) 112 of HDMI switch 106. Client device 102 include an application(s) 120 (“app” 120, hereinafter) configured to access blended search host 104 and/or HDMI switch 106 for initiating blended searches based on user inputs as described herein.

For example, users of HDMI switch 106 may be authenticated to a user account by blended search host 104 and/or HDMI switch 106 to access blended search service 108 to search for content across disparate content sources (although in embodiments such searches may not require authentication). Users may be authenticated through HDMI switch 106 or through client device 102 by credentials. In embodiments, users may be authenticated via plug-ins for web browsers or apps associated with their blended search service accounts.

Blended search host 104 and/or additional content sources 116 may comprise one or more server computers or computing devices, which may include one or more distributed and/or “cloud-based” servers. Blended search host 104 may also include internal and/or external storage (not shown). Blended search host 104 may include a blended search service 108 that is configured to perform operations and functions for performing blended searches for content to obtain search results from different, disparate content sources, as described in the instant embodiments. Blended search service 108 may be implemented in hardware or hardware combined with one or both of software and/or firmware.

It should be noted that as described herein, embodiments are applicable to any type of device or system for content searches over different content sources. One example is where blended search service 108 is a “cloud” service in a network architecture/platform of blended search host 104. A cloud platform includes a networked set of computing resources, including servers, routers, etc., that are configurable, shareable, provide data security, and are accessible over a network such as the Internet. Cloud applications run on the computing resources, often atop operating systems that run on the computing resources, for servicing devices/systems as described herein. A cloud platform may support multiple hosting entities, where cloud platform-based software, e.g., for blended searches, services these entities. Furthermore, a cloud platform may support hypervisors implemented as hardware, software, and/or firmware that run virtual machines (emulated computer systems, including operating systems) for hosting entities. A hypervisor may present a virtual operating platform for the described entities.

HDMI devices 118 may include one or more source devices and/or sink devices such as, but without limitation, a television or other HDMI display, a set top box (STB), media and/or multimedia players, content streaming devices, game consoles, etc., that connect to HDMI switch 106 via HDMI connections.

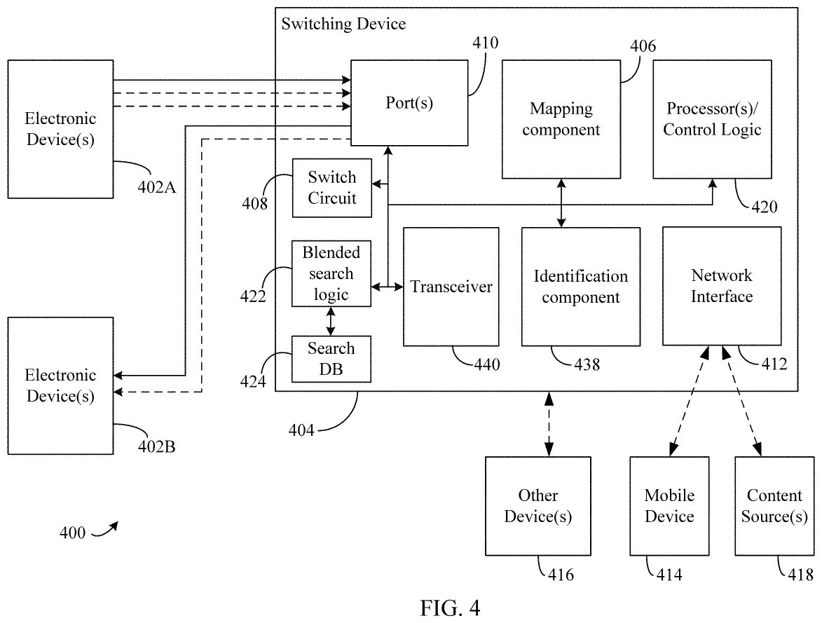

HDMI switch 106 may include one or more HDMI input ports and one or more HDMI output ports to connect to HDMI devices 118. HDMI switch 106 as shown includes UI(s) 112 and blended search logic 114. UI(s) 112 may be provided and configured for performing blended searches for content across different, disparate content sources, as described in the instant embodiments. Blended search logic 114 may be configured to perform and/or facilitate blended searches over disparate content sources as well as to provide results in specific configurations to portions of UIs 112 for improvements thereof and improvements to content searching. Blended search logic 114 is described in further detail below with respect to FIGS. 4 and 5.

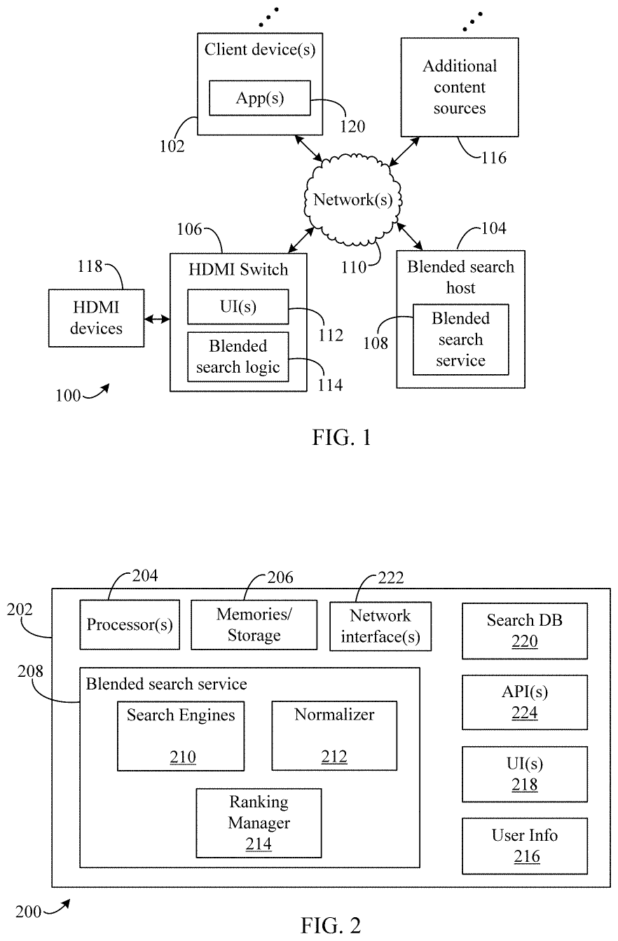

FIG. 2 is a block diagram of a blended search host system 200 (“system 200” herein) configured for implementing blended searches for content across different, disparate content sources. System 200 may be an embodiment of system 100 in FIG. 1. System 200 is described as follows.

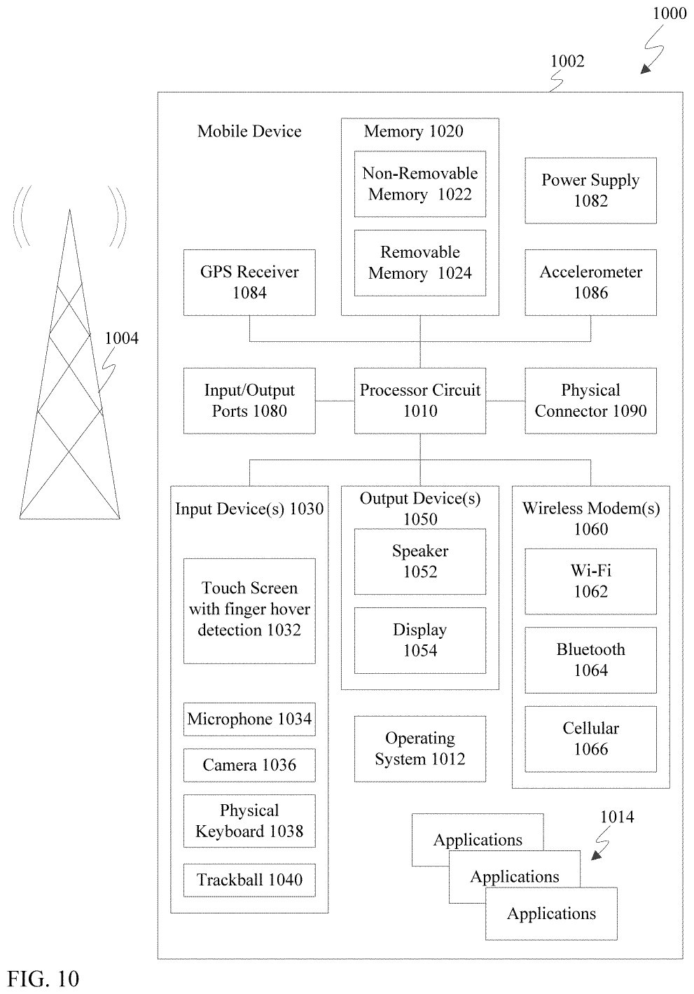

System 200 includes a blended search host 202, which may be an embodiment of blended search host 104 of FIG. 1, and may be any type of server computer or computing device, as mentioned elsewhere herein, or as otherwise known, including cloud-based server implementations. As shown in FIG. 2, system 200 and blended search host 202 include one or more of a processor (“processor”) 204, one or more of a memory and/or other physical storage device (“memory”) 206, one or more network interfaces (“network interface”) 222. System 200 and blended search host 202 also include a blended search service 208 that may be an embodiment of blended search service 108 of FIG. 1. System 200 and blended search host 202 may also include user information 216, UI(s) 218, search DB 220, and application programming interfaces (APIs) 224. System 200 and blended search host 202 may also include additional components (not shown for brevity and illustrative clarity) including, but not limited to, components and subcomponents of other systems herein, as well as those described below with respect to FIGS. 10 and 111, such as different types of storage devices and/or an operating system (OS).

Processor 204 and memory 206 may respectively be any type of processor circuit/processing system or memory that is described herein, and/or as would be understood by a person of skill in the relevant art(s) having the benefit of this disclosure. Processor 204 and memory 206 may each respectively comprise one or more processors or memories, different types of processors or memories, remote processors or memories, and/or distributed processors or memories. Processor 204 comprises circuitry that is configured to execute computer program instructions such as but not limited to embodiments of blended search service 208, which may be implemented as computer program instructions for blended searches for content across different, disparate content sources, etc., as described herein. Memory 206 is configured to store such computer program instructions/code, as well as to store other information and data described in this disclosure including, without limitation, search DB 220, user information 216, prior search terms and/or results, information related to content (e.g., in DB 220), and/or the like. In some embodiments, an external storage may also be included in system 200, e.g., external to blended search host 202.

Network interface 222 may be any type of wired and/or wireless network adapter, modem, etc., configured to enable system 200 to communicate with other devices over a network, such as communications between system 200 and other devices utilized in embodiments, such as described above with respect to FIG. 1 over a network such as network 110.

User information 216 may include, without limitation, user identifiers and account/device information, authentication credentials, and/or the like. Search DB 220, described in further detail herein, may include locally stored results of prior searches across disparate content sources, as well as information, images, metadata, logos, date, length, time of display, etc., associated with the results, as shown and described herein. This information may include previews, titles, sources, descriptions of content, types of content, poster art, and/or the like. Search DB 220 may be organized as a database of results based on topic, content source, and/or the like, that may be searchable/queried during content searches by blended search service 208, APIs 224, or blended search logic 114 in FIG. 1, to provide results to HDMI switch 106 and/or client device 106 for display to users via UI(s) 112 and/or app 120.

UI(s) 218 may include one or more fields and/or controls for display/selection of blended search results by users. API(s) 224 may be configured to receive requests to initiate blended searches as described herein, including calls to search DB 220, to locate and provide one or more blended search results. In embodiments, API(s) 224 may push blended search results to HDMI switches and/or user devices without explicit requests therefor, e.g., based on prior searches, user content consumption habits, etc.

Blended search service 208 is configured to perform functions and operations for blended searches for content across different, disparate content sources, according to embodiments herein. Blended search service 208 includes search engines 210, a normalizer 212, and a ranking manager 214, which are described in further detail below.

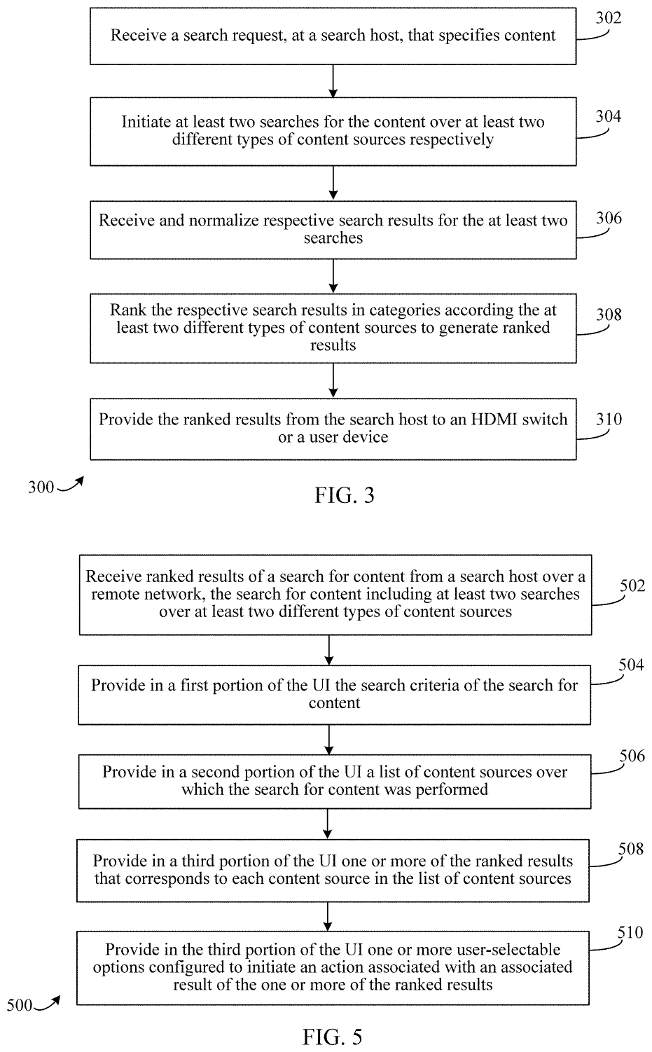

Turning to FIG. 3, a flowchart 300 for blended searches for content across different, disparate content sources is shown, according to an example embodiment. System 100 in FIG. 1 and/or system 200 in FIG. 2 may operate according to flowchart 300. Further structural and operational examples will be apparent to persons skilled in the relevant art(s) based on the following description.

Flowchart 300 begins at step 302. In step 302, a search request is received, at a search host, that specifies content. For instance, blended search service 208 of blended search host 202 may be configured to receive a search request via network interface 222. The search request may specify content to be searched for over different, disparate content sources. In embodiments, different and/or disparate content sources may be content sources that require searches to be performed in a proprietary manner or a manner that is not shared by other content sources, or may content sources that are accessed for content searches by through different communication connections (e.g., the Internet versus a local area network versus a point to point connection, etc.). As an example, YouTube®, a DVR of a user, a streaming device of a user, search DB 220, etc., are different, disparate content sources.

In step 304, at least two searches are initiated for the content over at least two different types of content sources respectively. For example, based on the request from step 302, blended search service 208 may be configured to initiate searches of disparate content sources via corresponding ones of search engines 210. Search engines 210 may be configured to perform specific, proprietary search operations over content sources, as described herein. As an example, a search for specific content may be initiated against YouTube® and a user's local DVR or content server, and performed by search engines 210. It is contemplated herein that any number of different content sources, e.g., including those described, may be performed in step 304.

In step 306, respective search results for the at least two searches are received and normalized. For instance, search engines 210 may receive results for the searches in step 304, and normalizer 212 may be configured to normalize the search results. That is, different content sources may provide differently formatted search results, and normalizer 212 is configured to modify the search results into a consistent format for presentation to a user in a single experience such as a 10 foot experience, e.g., via a UI, with the user's TV and HDMI switch, or a 2 foot experience with a user's personal device. Search results may be normalized for content title, description, metadata, etc. In other words, results from different sources are blended in a way that provides a uniform result for the user to review and select content resulting from the search.

In step 308, the respective search results are ranked in categories according the at least two different types of content sources to generate ranked results. For example, ranking manager 214 may be configured to rank, i.e., to weight, the search results that have been normalized by normalizer 212 in step 306. Search results may be ranked/weighted according to one or more of information in metadata, textual matches with respect to search terms, by relevancy, by times content is available, by popularity of content, quality of content (e.g., rating), the source of content, newness of content, a geographical location of the requesting user, language of the requesting user, viewing history of the requesting user (e.g., has the user watched the content before, and if so, how many times), and/or the like.

In step 310, the ranked results are provided from the search host to an HDMI switch or a user device. For instance, blended search service 208 may be configured to provide the ranked results generated in step 308 to an HDMI switch or a user device, such as HDMI switch 104 or client device 102, as shown in FIG. 1. The HDMI switch and/or user device may be configured to display the provided ranked results via UIs and/or applications in ways that improve upon the UI operation/presentation and the efficacy of the display.

Additional details regarding HDMI switches and devices of users are provided below.

For example, FIG. 4 is a block diagram of an HDMI switch system 400 (“system 400” hereinafter) having an HDMI switch 404 (“switch 404” hereinafter), according to an example embodiment. Switch 404 may be a further embodiment of HDMI switch 106 of FIG. 1.

In embodiments, switch 404 includes one or more components such as ports 410, one or more storages (not shown for illustrative clarity), one or more processors and/or control logic 420, a transceiver 440, a mapping component 406, a switching circuit 408, and/or an identification component 438. Switch 404 may be coupled to one or more HDMI sources of electronic devices 402a and/or to one or more HDMI sinks of electronic devices 402b via HDMI connections as would be understood by persons of skill in the relevant art having the benefit of this disclosure.

Ports 410 may be one or more HDMI ports (i.e., HDMI connectors) as described herein. Ports 410 may be dynamically configured as input ports (e.g., corresponding to sources devices) or output ports (e.g., corresponding to sink devices) according to the described embodiments. Ports of ports 410 may be referred to as universal HDMI ports as these ports may be dynamically configured as inputs or outputs on connection of an HDMI device. In other words, in system 400 there is no need to pre-define the function of any port of ports 410. Thus, the same physical port for ports 410 can act as an input or an output depending on which type of HDMI device is connected, and this considerably enhances the convenience of use for an HDMI switch. The port interface scheme is such that a repeater device or a switch (e.g., switch 404) is able to detect the type of device connected to the HDMI port and automatically configure the internal circuits to support either a sink or a source.

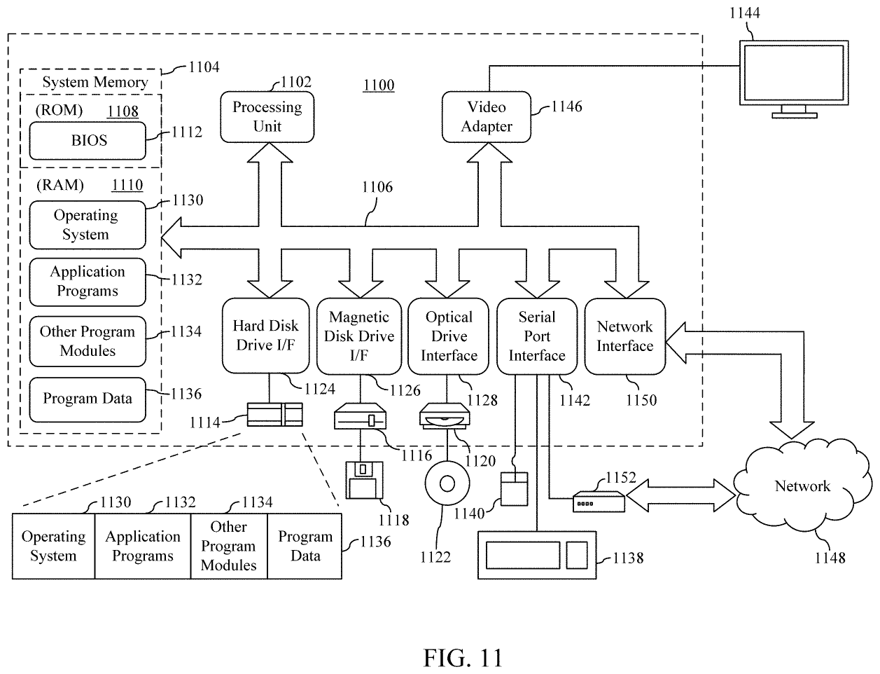

Processor(s) or control logic 420 may be one or more of any processing device or processor described herein, such as, but not limited to, those described below with respect to FIGS. 10 and 11, and may be configured as described elsewhere herein.

Transceiver 440 is configured to receive and transmit wired and/or wireless data according to any protocol and/or embodiment described herein, such as HDMI in HDMI switch embodiments. For instance, transceiver 440 is configured to receive and to transmit audio/video signals according to HDMI protocols from HDMI sources and HDMI sinks respectively.

While not shown, switch 404 may include detectors that are configured to detect indicia of operational modes to determine a type of an HDMI enabled electronic device connected to ports 410 (i.e., whether the device is a source or a sink). In embodiments, detectors may be configured to make such a detection/determination based on signals received from pins of ports 410.

Identification component 438 may be implemented as hardware (e.g., electrical circuits), software (e.g., as executed by control logic, a processor or processing device), and/or firmware. Identification component 438 is configured to identify electronic devices (e.g., HDMI sources and HDMI sinks) coupled or connected to HDMI ports 410. That is, for each HDMI source and HDMI sink, identification component 438 is configured to determine one or more identifiers of the connected electronic devices, such as, but not limited to a type of the electronic device (e.g., a DVD player, a Blu-ray player, a video game console, a streaming media device, a TV, an HDTV, a projector, etc.), a brand name of the electronic device, a manufacturer of the electronic device, a model number of the electronic device, etc. These identifiers may be determined according to various techniques, such as, but not limited to: techniques based on HDMI consumer electronics control (CEC), source product description (SPD), extended display identification data (EDID), video data, audio data, IP network information, remote control operation by user, voice input from user, and explicit device selection by user. Identification component 438 provides the one or more identifiers to mapping component 406.

Mapping component 406 may be implemented as hardware (e.g., electrical circuits) software (e.g., as executed by control logic, a processor or processing device), and/or firmware. Mapping component 406 is configured to operate and perform functions according to the embodiments described herein. For example, mapping component 406 is configured to determine a device-to-port mapping based on one or more identifiers determined by identification component 438. Mapping component 406 may generate a data structure (e.g., a table or the like) that associates the identifiers for any given identified electronic device with the HDMI port of ports 410 to which that electronic device is coupled. In this way, the device-to-port mapping may indicate that a first electronic device (e.g., a STB, a Blu-ray® player or streaming device of a streaming service) such as an HDMI source is connected to a first port of ports 410, and that a second electronic device (e.g., a TV) such as an HDMI sink is connected to a second port of ports 410.

Based at least in part on one or more of the operating mode, the identifiers, and mappings received from detectors, identification component 438, and/or mapping component 406, processor/control logic 420 is configured to provide a control signal to switching circuit 408 and/or to transceiver 440, causing switching circuit 408 to connect the identified electronic devices on ports of ports 410 to corresponding receiver portions or transmitter portions of transceiver 440 and/or causing transceiver 440 to output desired content received from HDMI sources on a specified output port of ports 410.

Switching circuit 408 is configured to provide switched connections between ports 410 and transceiver 440. That is, switching circuit 408 may provide a connection between any port of ports 410 and any receiver component or transmitter component of transceiver 440. Switching circuit 408 may comprise one or more switch circuit portions (e.g., comprising one or more switches/switching elements) and may be combined or used in conjunction with other portions of system 400.

Network interface 412 may be similarly configured as network interface(s) 222 of FIG. 2 and enable communications over networks for switch 404. For instance, switch 404 may communicate over a network with a mobile device 414, content sources 418, or other devices 416 as shown. In embodiments, any type of computing/communications device, e.g., of a user of switch 404, may be included in lieu of, or in addition to, mobile device 414. Content sources 418 may include content sources as described herein, such as content sources available over a network or point-to-point connection, as well as blended search host 104 of FIG. 1 or blended search host 202 of FIG. 2, as described above.

Other devices 416 may include remote controllers or any device which may otherwise communicate with switch 404. In embodiments, a remote controller, smart device, and/or Internet of Things (IoT) device such as an Echo Dot® form Amazon Corp. of Seattle, Wash. (and/or the like), of other devices 416 may be configured to receive voice or character inputs for performing blended searches. For example, users can interact with and send in search queries via Google Home® and Alexa® smart speakers by asking “Alexa/Hey Google, tell Caavo to search for {term}.” The smart speaker can then send the query/search criteria to blended search host 104, blended search host 202, and/or switch 404, which will in turn process the criteria, initiate searches, and provide blended search results to a UI for display to the user. In such cases, the user can then select an item to watch and proceed.

It is also contemplated herein that other devices 416 may include various types of smart speakers (e.g., smart speakers from Sonos®, Bose®, Heios®, etc.) that may be used to receive user voice inputs for performing blended searches. Likewise, hardware associated with music services, or UIs of such services, may comprise other devices 416 and may be used to receive inputs for blended searches (e.g., Spotify®, Pandora®, Apple Music®, etc.).

Additionally, it is further contemplated herein that embodiments for blended searches also encompass searches for devices and/or services, such as for IoT devices. As an example, a search for IoT devices on a network (e.g., a home network associated with switch 404) may be performed. In this example, lights, shades or curtains, garage door openers, refrigerators or other home appliances, alarm systems, sprinkler systems, or any other type of smart- or IoT-device, or categories of such devices, may be searched from all existing or active devices on the network. Embodiments also provide for location-based searching in this context, such as for devices in specific rooms (e.g., rooms in a house, an apartment, an office building, etc.).

As one example, a user may provide a voice or text input for “Lights” in which search results for all lights available on the network for control are provided back. In this example, a location of a user may be determined and the lights in the room associated with the user's location may be provided as top-ranked results. In another example, a user may say “Kitchen” or “Devices in the kitchen” in which case a search may provide results for all IoT devices located in the kitchen. Similarly, a search for “Devices” may return search results for all devices on the network, or a search for “lights” may return search results for all lights. Such results may be provided under a “Top Results” category in a UI, as described below, or in another category such as “Devices” as appropriate. In the context of these examples, a blended search is performed in at least so far as different types of devices and/or different locations are searched for, but such a search is based on a single criteria, and search results are provided in a single UI. In embodiments, searches for devices on a network may include searching one or more of a network itself and/or a database (e.g., as described below for switch 404). Devices may be searched based on device lists in a router or the like of the network, based on a broadcast/multicast signal provided to network devices, based on a list of devices maintained in a database, and/or the like.

In yet additional embodiments, a blended search as described herein may also comprise a control function. For example, a user may say “Turn on lights in the kitchen.” In response, the query/criteria may be provided to switch 404 which searches for lights located in the kitchen, and upon obtaining the results of the search, switch 404 may provide a control signal that causes the corresponding lights in the kitchen to be turned on. In such embodiments, the search results for the lights in the kitchen may also be provided to a UI for display to the user.

Accordingly, switch 404 includes may also include blended search logic 422 and a search DB 424. Search DB 424 may be an embodiment of search DB 222 of FIG. 2.

Blended search logic 422 may be an embodiment of one or more portions of blended search service 208 of FIG. 2, in some examples. Blended search logic 422 may be configured to receive requests/queries for content via a remote controller, via a UI of switch 404, via app 120 of FIG. 2, etc., and to provide the request for content to blended search host 104 of FIG. 1 and/or blended search host 202 of FIG. 2, i.e., relay searching, in embodiments. Blended search logic 422 may be configured to search locally or remotely accessible devices/content sources such as those described above with respect to FIG. 4, including search DB 224. Additionally, blended search logic may be configured to provide a list of such devices/content sources, and/or results from blended searches thereof, to blended search host 104 of FIG. 1 and/or blended search host 202 of FIG. 2 for blended search purposes. Results for local blended searches, for content or devices/services, that are performed by switch 404, as described above (e.g., for a home network), may be provided to a blended search host and/or to search DB 424 for persistence in and/or updating thereof, and/or for later use in blended searches.

Blended search logic 422 may also be configured to cause blended search results to be displayed to users via UIs (e.g., subsequent to provision to a UI). For example, switch 404 may include UIs such as UI(s) 112 described above for switch 106 of FIG. 1 (not shown in FIG. 4 for brevity and illustrative clarity). Blended search logic 422 may be configured to provide instructions to processor/control logic 420 and/or to network interface 412 to provide connections to HDMI source devices via ports 410 and/or content sources via a network, respectively, for providing content/blended search results to users for selecting, viewing, and/or consuming via the UIs. Blended search results (and/or content or information therein) may be stored or cached locally at switch 404 in association with blended search logic 422 in search DB 224. Blended search results (and/or content or information therein) may be updated by blended search host 202 and/or by blended search logic 422 of switch 404 periodically or dynamically when blended searches are performed.

In embodiments, search DB 424 may be updated to account for “content windows,” i.e., the specific time period (or window) for which a specific source of content such as a service provider is granted rights to provide the content. As an example, granted rights for providing TV shows or movies to service providers may be for very specific periods of time where only during this time window is a service provide allowed to provide the content. After the time period/window expires, the content rights may be granted to another provider, and so no. Blended search logic 422 may track content windows and update search DB automatically.

In accordance with the embodiments herein, blended searches over disparate content sources improve the user and UI experience through the described platform by providing blended search results in a single UI that is formatted to display content search results in a manner by which the disparate content sources are accounted for while the search results are presented and organized by rank and source.

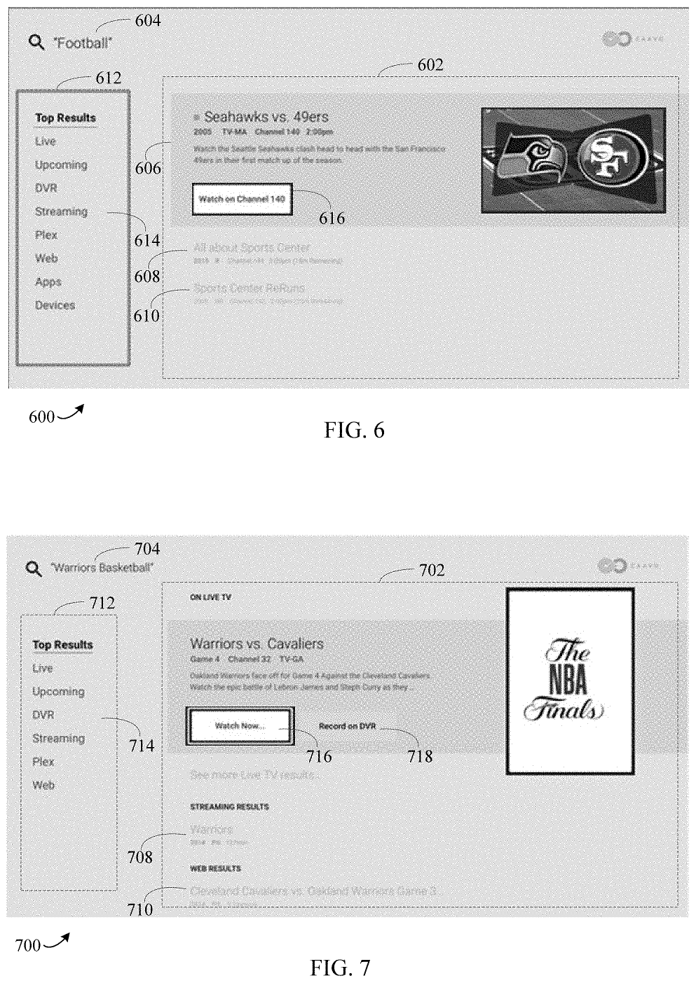

FIGS. 5-9 will now be described. In FIG. 5, a flowchart 500 for blended searches for content across different, disparate content sources is shown, according to an example embodiment. System 100 in FIG. 1, system 200 in FIG. 2, and/or system 400 in FIG. 4 may operate according to flowchart 500. FIGS. 6, 7, 8, and 9 respectively show a UI 600, a UI 700, a UI 800, and a UI 900, which may be embodiments of UIs 112 and/or UIs 218, as described above with respect to FIG. 1 and in FIG. 2. Further structural and operational examples will be apparent to persons skilled in the relevant art(s) based on the following description.

In embodiments, any of step 504, step 506, step 508, and/or step 510 may be optional.

Flowchart 500 begins at step 502. In step 502, ranked results of a search for content are received from a search host over a remote network, the search for content including at least two searches over at least two different types of content sources. For instance, blended search logic 422 of switch 404 may be configured to receive ranked results of a blended search for content via network interface 412 from blended search host 202 of FIG. 2. The blended search may have been performed over different, disparate content sources, as described herein and noted above in flowchart 300 in FIG. 3.

In step 504, in a first portion of the UI the search criteria of the search for content are provided. For example, FIG. 6 shows a UI 600 in which blended results for search criteria of a blended search for “Football” content are provided. As illustrated, “Football” is displayed in a portion 604 (a first portion) of UI 600 next to the magnifying glass search icon.

Likewise, FIG. 7 shows a UI 700 in which blended results for search criteria of a blended search for “Warriors Basketball” content are provided. As illustrated, “Warriors Basketball” is displayed in a portion 704 (a first portion) of UI 700 next to the magnifying glass search icon.

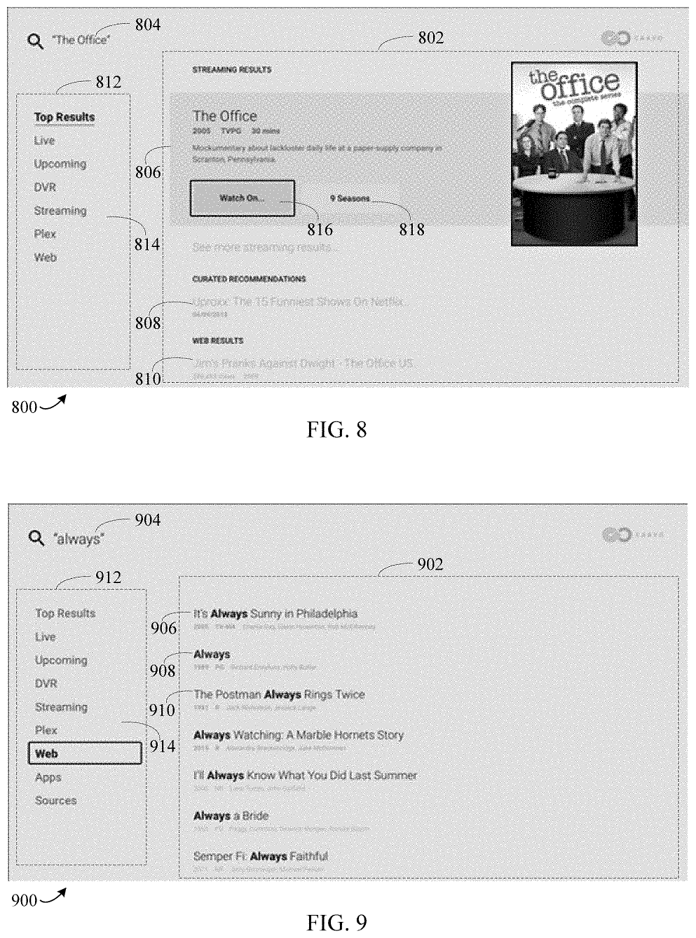

FIG. 8 shows a UI 800 in which blended results for search criteria of a blended search for “The Office” content are provided. As illustrated, “The Office” is displayed in a portion 804 (a first portion) of UI 800 next to the magnifying glass search icon.

FIG. 9 shows a UI 900 in which blended results for search criteria of a blended search for “always” content are provided. As illustrated, “always” is displayed in a portion 704 (a first portion) of UI 900 next to the magnifying glass search icon. In embodiments, blended search logic 422 may be configured to provide the search criteria to ones of the described UIs for display to a user.

In step 506, in a second portion of the UI a list of content sources over which the search for content was performed is provided. For instance, each of UI 600, UI 700, UI 800, and UI 900 show a listing of disparate content sources. For UI 600, a listing 614 is shown in a second portion 612. Listing 614 includes different content sources including, without limitation, Top Results, Live (e.g., live TV), Upcoming (e.g., future Live TV content), DVR (e.g., recorded content from a programming provider), Streaming (e.g., content streamed from applications/services such as Netflix®, Hulu®, etc.), Plex (e.g., content stored on a Plex Server®), Web (e.g., YouTube® content, podcasts from iHeartRadio®, etc.), Audio (e.g., iTunes® content)), User Devices, and/or the like. Ranked search results displayed, as described herein, are shown as corresponding to the heading “Top Results” in listing 614, which may be an initial default selection, in embodiments.

For UI 700, a listing 714 is shown in a second portion 712. Listing 714 includes different content sources/categories including, without limitation, Top Results, Live (e.g., live TV), Upcoming (e.g., future Live TV content), DVR (e.g., recorded content from a programming provider), Streaming (e.g., content streamed from applications/services such as Netflix®, Hulu®, etc.), Plex (e.g., content stored on a Plex Server®), Web (e.g., YouTube® content, podcasts from iHeartRadio®, etc.), and/or the like. Ranked search results displayed, as described herein, are shown as corresponding to the heading “Top Results” in listing 714, which may be an initial default selection, in embodiments.

For UI 800, a listing 814 is shown in a second portion 812. Listing 814 includes different content sources/categories including, without limitation, Top Results, Live (e.g., live TV), Upcoming (e.g., future Live TV content), DVR (e.g., recorded content from a programming provider), Streaming (e.g., content streamed from applications/services such as Netflix®, Hulu®, etc.), Plex (e.g., content stored on a Plex Server®), Web (e.g., YouTube® content, podcasts from iHeartRadio®, etc.), and/or the like. Ranked search results displayed, as described herein, are shown as corresponding to the heading “Top Results” in listing 814, which may be an initial default selection, in embodiments.

For UI 900, a listing 914 is shown in a second portion 912. Listing 914 includes different content sources/categories including, without limitation, Top Results, Live (e.g., live TV), Upcoming (e.g., future Live TV content), DVR (e.g., recorded content from a programming provider), Streaming (e.g., content streamed from applications/services such as Netflix®, Hulu®, etc.), Plex (e.g., content stored on a Plex Server®), Web (e.g., YouTube® content, podcasts from iHeartRadio®, etc.), and/or the like. Ranked search results displayed, as described herein, are shown as corresponding to the heading “Web” in listing 914, which may be selected from the content sources/categories in listing 914, in embodiments.

In embodiments, the content sources/categories listed in a listing as described above may comprise all or a portion of content sources for which a search result(s) was returned.

The listings of content sources/categories described may be implemented as a filter for viewing blended search results which allow a user to view all ranked results from a particular content source of their search. In embodiments, blended search logic 422 may be configured to perform step 506 with UIs as described herein. In other words, selecting one of the content sources from the second portion of the UIs, as provided in step 506, may show additional results for the specific content source. This embodiment is shown in further detail in UI 900 where the “Web” content source is selected by the user and a list of ranked search results for the web content sources is provided.

As noted, it is also contemplated herein that, initially, a default display may be provided to a UI such that Top Results over all content sources are displayed. In such embodiments, the search results illustrated for Top Results may ordered according to a ranking of all search results, as described herein. It should be noted that any number of ranked results for a given content source may be provided and displayed to the user, according to embodiments.

In step 508, in a third portion of the UI one or more of the ranked results that corresponds to each content source in the list of content sources are provided. For example, UI 600 of FIG. 6 is configured to receive and show in a third portion 602 ranked search results for a blended search of “Football” that correspond to each content source in listing 614 as Top Results of content sources/categories. Third portion 602 may include one or more sub-portions in which individual search results are provided.

For instance, a sub-portion 606 is shown as being provided for a football game entitled “Seahawks vs. 49ers,” which is the first ranked search result. A sub-portion 608 and a sub-portion 610 are also exemplarily shown as having additional search results for the blended search of “Football” that correspond to the second ranked and the third ranked search results, respectively That is, these sub-portions may be displayed based on a ranking, the determination of which is described above.

In this illustrated embodiment, the top 3 ranked results for a blended search are shown, for Live TV results, although additional results may be provided and displayed, and other results for other content sources may be provided and viewed/displayed by scrolling downward.

Similarly, UI 700 of FIG. 7 shows that in a third portion 702 of UI 700, ranked results for “Warriors Basketball” are listed for different ones of the content sources/categories in listing 714 as Top Results. Third portion 702 may include one or more sub-portions in which additional individual search results are provided. The top ranked search result is for Live TV and is shown first, followed by a search result from Streaming Results, and then a search result from Web Results.

For instance, a sub-portion 706 is shown as being provided for a basketball game entitled “Warriors vs. Cavaliers” which corresponds to a live television broadcast. A sub-portion 708 for streaming results and a sub-portion 710 for web results are also exemplarily shown as having additional search results for these respective content sources for the blended search of “Warriors Basketball” that correspond to the second ranked and the third ranked search results, respectively. That is, these sub-portions may be displayed based on a ranking, the determination of which is described above.

In this illustrated embodiment, the top 3 ranked results for a blended search are shown, for Live TV, Streaming, and Web results, although additional results may be provided and displayed, and other results for other content sources may be provided and viewed/displayed by scrolling downward.

UI 800 of FIG. 8 shows ranked search results for “The Office” search criteria in a third portion 802 of UI 800 as Top Results. Third portion 802 may include one or more sub-portions in which additional individual search results are provided. UI 800 shows the top ranked result for Streaming Results first, followed by Curated Recommendations (i.e., a list from a content list provider (here, e.g., “Uproxx”)), and then Web Results.

For instance, a sub-portion 806 is shown as being provided for a broadcast episode of “The Office,” which is the first ranked search result. A sub-portion 808 and a sub-portion 810 are also exemplarily shown as having additional search results for the blended search of “The Office” that correspond to the second ranked and the third ranked search results, respectively That is, these sub-portions may be displayed based on a ranking, the determination of which is described above.

In this illustrated embodiment, the top 3 ranked results for are shown, for Live TV, Streaming, and Web results, although additional results may be provided and displayed, and other results for other content sources may be provided and viewed/displayed by scrolling downward.

UI 900 of FIG. 9 shows ranked search results for “always” search criteria in a third portion 902 of UI 900 under the category Web (i.e., search results obtained from the web). Third portion 902 may include one or more sub-portions in which additional individual search results are provided. As an example, UI 900 shows the top ranked result for the Web as the content source.

For instance, a sub-portion 906 is shown as being provided for the television show “It's Always Sunny in Philadelphia,” which is the first ranked search result. A sub-portion 908 and a sub-portion 910 are also exemplarily shown as having additional search results for the blended search of “always” that correspond to the second ranked and the third ranked search results, a movie entitled “Always” and a movie entitled “The Postman Always Rings Twice,” respectively. That is, these sub-portions may be displayed based on a ranking, the determination of which is described above.

In this illustrated embodiment, the top 7 ranked results for are shown for the Web as the content source (with ranked search results 4-7 shown but not labeled for brevity and illustrative clarity), although additional results may be provided and displayed, and other results for other content sources may be provided and viewed/displayed by scrolling downward.

Additionally, as shown in the UIs described for step 508, there may also be provided in the third portion of the UIs a selectable object to view more results from one or more of the content sources. For example, it should be noted that listing 914 in second portion 912 is illustrated as “Web” having been selected, e.g., by a user-viewer, specifically for display of web results (i.e., Internet results) for the search criteria “always” as provided by the box around “Web” in listing 914.

In embodiments, blended search logic 422 may be configured to perform step 508 with UIs as described herein.

In step 510, in the third portion of the UI one or more user-selectable options are provided that are configured to initiate an action associated with an associated result of the one or more of the ranked results. For instance, UI 600 of FIG. 6 shows a selectable object 616 (“Watch on Channel 140”) in third portion 602 of UI 600 which, when selected, initiates actions of switch 404 to allow the user to watch content associated with the “Seahawks vs. 49ers” search result for the blended search on “Football.”

UI 700 of FIG. 7 shows a selectable object 716 (“Watch Now”) for “Warriors vs. Cavaliers” to initiate actions of switch 404 to allow the user to watch the content, as well as a selectable option 718 (“Record”) for the user's DVR to initiate recording of the content.

UI 800 of FIG. 8 shows a selectable option 816 (“Watch On . . . ”) that initiates actions to provide the user with different streaming options through which “The Office” may be watched. Other episodes of this content may be viewed, selected, and watched via a selectable option 818 (“Seasons”).

As noted above, UI 900 of FIG. 9 shows a number of search results in third portion 902, each of which may be selectable by the user to cause initialization actions of switch 404 to allow the user to watch content associated with the selected search result provided in third portion 902.

In the UIs described with respect to flowchart 500, additional information, images, etc., are also provided to inform the user about the particular content associated with the blended search results and allow the user to select the desired content. It is also contemplated that animations, previews, trailers, and live TV may also be provided and shown in the described and illustrated UIs.

### III. FURTHER EXAMPLE EMBODIMENTS AND ADVANTAGES

As described, systems and devices embodying the techniques herein may be configured and enabled in various ways to perform their respective functions. In embodiments, one or more of the steps or operations of any operation, process, flowchart, and/or flow diagram described herein may not be performed. Moreover, steps or operations in addition to or in lieu of those in any operation, process, flowchart, and/or flow diagram described herein may be performed. Further, in examples, one or more operations of any operation, process, flowchart, and/or flow diagram described herein may be performed out of order, in an alternate sequence, or partially (or completely) concurrently with each other or with other operations.

Moreover, UI improvements are realized by providing blended search results for content from disparate content sources in a centrally-hosted UI that allows the content to be viewed by selection which may be filtered according to rankings and/or categories/content sources. Accordingly, a centralized, 10 foot experience (or 2 foot experience) for any type of viewable content identified in a search over different, unrelated sources with different search mechanisms is realized.

Furthermore, the described embodiments do not exist in software implementations for blended searches over different, disparate content sources. That is, the current state of the art lacks the ability to centralize and provide actionable search results for content from sources that are unrelated, like the embodiments described herein.

Additionally, content for user viewing in a 10 foot experience (or 2 foot experience) may be provided or hosted or stored in/by any number of content sources that are not related and that utilize proprietary methods of searching. The advent of DVRs and multimedia streaming services, different amounts of content from TV programming providers, the growth of content and offerings from web-based entities like YouTube®, and the ability to store content on local servers prohibits users from conducting a single search to provide results from across all these disparate sources. Instead, users much separately search each provider for a topic or item which does not allow the user to view all results in a single UI. In stark contrast, the instant embodiments provide for this ability.

The additional examples and embodiments described in this Section may be applicable to examples disclosed in any other Section or subsection of this disclosure.

### IV. EXAMPLE COMPUTER IMPLEMENTATIONS

Embodiments described herein may be implemented in hardware, or hardware combined with software and/or firmware. For example, embodiments described herein may be implemented as computer program code/instructions configured to be executed in one or more processors and stored in a computer readable storage medium. Alternatively, embodiments described herein may be implemented as hardware logic/electrical circuitry.

As noted herein, the embodiments described, including, such as system 100 of FIG. 1, system 200 of FIG. 2, and system 400 of FIG. 4, along with any components and/or subcomponents thereof, UIs, as well any operations and portions of flowcharts/flow diagrams described herein and/or further examples described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments described herein may be implemented in one or more computing devices similar to a mobile system and/or a computing device in stationary or mobile computer embodiments, including one or more features of mobile systems and/or computing devices described herein, as well as alternative features. The descriptions of mobile systems and computing devices provided herein are provided for purposes of illustration, and are not intended to be limiting. Embodiments may be implemented in further types of computer systems, as would be known to persons skilled in the relevant art(s).

FIG. 11 is a block diagram of an exemplary mobile system 1100 that includes a mobile device 1102 that may implement embodiments described herein. For example, mobile device 1102 may be used to implement any system, client, or device, or components/subcomponents thereof, in the preceding sections. As shown in FIG. 11, mobile device 1102 includes a variety of optional hardware and software components. Any component in mobile device 1102 can communicate with any other component, although not all connections are shown for ease of illustration. Mobile device 1102 can be any of a variety of computing devices (e.g., cell phone, smart phone, handheld computer, Personal Digital Assistant (PDA), etc.) and can allow wireless two-way communications with one or more mobile communications networks 1104, such as a cellular or satellite network, or with a local area or wide area network.

Mobile device 1102 can include a controller or processor 1110 (e.g., signal processor, microprocessor, ASIC, or other control and processing logic circuitry) for performing such tasks as signal coding, data processing, input/output processing, power control, and/or other functions. An operating system 1112 can control the allocation and usage of the components of mobile device 1102 and provide support for one or more application programs 1114 (also referred to as “applications” or “apps”). Application programs 1114 may include common mobile computing applications (e.g., e-mail applications, calendars, contact managers, web browsers, messaging applications) and any other computing applications (e.g., word processing applications, mapping applications, media player applications).

Mobile device 1102 can include memory 1120. Memory 1120 can include non-removable memory 1122 and/or removable memory 1124. Non-removable memory 1122 can include RAM, ROM, flash memory, a hard disk, or other well-known memory devices or technologies. Removable memory 1124 can include flash memory or a Subscriber Identity Module (SIM) card, which is well known in GSM communication systems, or other well-known memory devices or technologies, such as “smart cards.” Memory 1120 can be used for storing data and/or code for running operating system 1112 and application programs 1114. Example data can include web pages, text, images, sound files, video data, or other data to be sent to and/or received from one or more network servers or other devices via one or more wired or wireless networks. Memory 1120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 1120. These programs include operating system 1112, one or more application programs 1114, and other program modules and program data. Examples of such application programs or program modules may include, for example, computer program logic (e.g., computer program code or instructions) for implementing one or more of system 100 of FIG. 1, system 200 of FIG. 2, and system 400 of FIG. 4, along with any components and/or subcomponents thereof, UIs, as well any operations and portions of flowcharts/flow diagrams described herein and/or further examples described herein.

Mobile device 1102 can support one or more input devices 1130, such as a touch screen 1132, a microphone 1134, a camera 1136, a physical keyboard 1138 and/or a trackball 1140 and one or more output devices 1150, such as a speaker 1152 and a display 1154. Other possible output devices (not shown) can include piezoelectric or other haptic output devices. Some devices can serve more than one input/output function. For example, touch screen 1132 and display 1154 can be combined in a single input/output device. Input devices 1130 can include a Natural User Interface (NUI).

One or more wireless modems 1160 can be coupled to antenna(s) (not shown) and can support two-way communications between processor 1110 and external devices, as is well understood in the art. Modem 1160 is shown generically and can include a cellular modem 1166 for communicating with the mobile communication network 1104 and/or other radio-based modems (e.g., Bluetooth 1164 and/or Wi-Fi 1162). At least one wireless modem 1160 is typically configured for communication with one or more cellular networks, such as a GSM network for data and voice communications within a single cellular network, between cellular networks, or between the mobile device and a public switched telephone network (PSTN).

Mobile device 1102 can further include at least one input/output port 1180, a power supply 1182, a satellite navigation system receiver 1184, such as a Global Positioning System (GPS) receiver, an accelerometer 1186, and/or a physical connector 1190, which can be a USB port, IEEE 1394 (FireWire) port, and/or RS-232 port. The illustrated components of mobile device 1102 are not required or all-inclusive, as any components can be deleted and other components can be added as would be recognized by one skilled in the art.

In an embodiment, mobile device 1102 is configured to implement any of the above-described features of flowcharts/embodiments herein. Computer program logic for performing any of the operations, steps, and/or functions described herein may be stored in memory 1120 and executed by processor 1110.

FIG. 12 depicts an exemplary implementation of a computing device 1200 in which embodiments may be implemented. For example, embodiments described herein may be implemented in one or more computing devices similar to computing device 1200 in stationary or mobile computer embodiments, including one or more features of computing device 1200 and/or alternative features. The description of computing device 1200 provided herein is provided for purposes of illustration, and is not intended to be limiting. Embodiments may be implemented in further types of computer systems and/or game consoles, etc., as would be known to persons skilled in the relevant art(s).

As shown in FIG. 12, computing device 1200 includes one or more processors, referred to as processor circuit 1202, a system memory 1204, and a bus 1206 that couples various system components including system memory 1204 to processor circuit 1202. Processor circuit 1202 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1202 may execute program code stored in a computer readable medium, such as program code of operating system 1230, application programs 1232, other programs 1234, etc. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computing device 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1230, one or more application programs 1232, other programs 1234, and program data 1236. Application programs 1232 or other programs 1234 may include, for example, computer program logic (e.g., computer program code or instructions) for implementing embodiments described herein, such as system 100 of FIG. 1, system 200 of FIG. 2, and system 400 of FIG. 4, along with any components and/or subcomponents thereof, UIs, as well any operations and portions of flowcharts/flow diagrams described herein and/or further examples described herein.

A user may enter commands and information into the computing device 1200 through input devices such as keyboard 1238 and pointing device 1240. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1202 through a serial port interface 1242 that is coupled to bus 1206, but may be connected by other interfaces, such as a parallel port, game port, or a universal serial bus (USB).

A display screen 1244 is also connected to bus 1206 via an interface, such as a video adapter 1246. Display screen 1244 may be external to, or incorporated in computing device 1200. Display screen 1244 may display information, as well as being a user interface for receiving user commands and/or other information (e.g., by touch, finger gestures, virtual keyboard, etc.). In addition to display screen 1244, computing device 1200 may include other peripheral output devices (not shown) such as speakers and printers.

Computing device 1200 is connected to a network 1248 (e.g., the Internet) through an adaptor or network interface 1250, a modem 1252, or other means for establishing communications over the network. Modem 1252, which may be internal or external, may be connected to bus 1206 via serial port interface 1242, as shown in FIG. 12, or may be connected to bus 1206 using another interface type, including a parallel interface.

As used herein, the terms “computer program medium,” “computer-readable medium,” and “computer-readable storage medium,” etc., are used to refer to physical hardware media such as the hard disk associated with hard disk drive 1214, removable magnetic disk 1218, removable optical disk 1222, other physical hardware media such as RAMs, ROMs, flash memory cards, digital video disks, zip disks, MEMs, nanotechnology-based storage devices, and further types of physical/tangible hardware storage media (including memory 1220 of FIG. 12). Such computer-readable media and/or storage media are distinguished from and non-overlapping with communication media and propagating signals (do not include communication media and/or propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1232 and other programs 1234) may be stored on the hard disk, magnetic disk, optical disk, ROM, RAM, or other hardware storage medium. Such computer programs may also be received via network interface 1250, serial port interface 1242, or any other interface type. Such computer programs, when executed or loaded by an application, enable computing device 1200 to implement features of embodiments discussed herein. Accordingly, such computer programs represent controllers of the computing device 1200.

Embodiments are also directed to computer program products comprising computer code or instructions stored on any computer-readable medium or computer-readable storage medium. Such computer program products include hard disk drives, optical disk drives, memory device packages, portable memory sticks, memory cards, and other types of physical storage hardware.

### V. CONCLUSION

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method performed by a search host, the method comprising:
receiving a search request, at a search host, that specifies content;
initiating at least two searches for the content over at least two different types of content sources respectively;
receiving and normalizing respective search results for the at least two searches;
ranking the respective search results in categories according the at least two different types of content sources to generate ranked results; and
providing the ranked results from the search host to a high-definition multimedia interface (HDMI) switch or a user device.

2. The method of claim 1, wherein the at least two different types of content sources includes a first content source of a first type that is associated with a source device connected to the switch via a local connection and includes a second content source of a second type that is accessed via a network that is remote to the switch.

3. The method of claim 2, wherein the first content source is a live television source, a streaming content source, a set top box, a local content server, a user device, an application of a user device, or an audio source; and
wherein the second content source is a remote audio source, a database of the search host, a website, or a web service.

4. The method of claim 3, wherein the at least two searches respectively include proprietary searching operations that are different from each other; or
wherein the method further comprises:
storing the respective search results in the database according to the search criteria and/or the content sources.

5. The method of claim 1, wherein ranking the respective search results includes ranking based on at least one of information in metadata of search results, textual matches in search results related to search terms, relevancy of search results, a number of times content in search results is available, popularity of content in search results, a rating or a quality of content in search results, a source of content in the search results, a newness of content in the search results, a geographical location of a requesting user, a language of the requesting user, or a viewing history of the requesting user.

6. The method of claim 1, wherein normalizing the respective search results includes modifying the search results from at least two different formats into a common format for presentation to a user in a single user interface (UI).

7. The method of claim 1, wherein the search results for the at least two searches include at least one of a title for content, a content source, a channel, a time the content will be provided, a rating, a duration, or a content description.

8. A system comprising:
at least one processor; and
at least one memory configured to store program code that is executable by the at least one processor, the program code configured to:
receive a search request, at a search host, that specifies content;
initiate at least two searches for the content over at least two different types of content sources respectively;
receive and normalize respective search results for the at least two searches;
rank the respective search results in categories according the at least two different types of content sources to generate ranked results; and
provide the ranked results from the search host to a high-definition multimedia interface (HDMI) switch or a user device.

9. The system of claim 8, wherein the at least two different types of content sources includes a first content source of a first type that is associated with a source device connected to the switch via a local connection and includes a second content source of a second type that is accessed via a network that is remote to the switch.

10. The system of claim 9, wherein the first content source is a live television source, a streaming content source, a set top box, a local content server, a user device, an application of a user device, or an audio source; and
wherein the second content source is a remote audio source, a database of the search host, a website, or a web service.

11. The system of claim 10, wherein the at least two searches respectively include proprietary searching operations that are different from each other; or
wherein the program code is configured to:
store the respective search results in the database according to the search criteria and/or the content sources.

12. The system of claim 8, wherein to rank the respective search results, the program code is configured to rank based on at least one of:
information in metadata of search results, textual matches in search results related to search terms, relevancy of search results, a number of times content in search results is available, popularity of content in search results, a rating or a quality of content in search results, a source of content in the search results, a newness of content in the search results, a geographical location of a requesting user, a language of the requesting user, or a viewing history of the requesting user.

13. The system of claim 8, wherein to normalize the respective search results, the program code is configured to:
modify the search results into a common format for presentation to a user in a single user interface (UI).

14. The system of claim 8, wherein the search results for the at least two searches include at least one of a title for content, a content source, a channel, a time the content will be provided, a rating, a duration, or a content description.

15. A computer-readable storage medium having programmed instructions recorded thereon that, when executed by a processing device, perform a method for providing a user interface (UI), the method comprising:
receiving ranked results of a search for content from a search host over a remote network, the search for content including at least two searches over at least two different types of content sources;
providing in a first portion of the UI the search criteria of the search for content;
providing in a second portion of the UI a list of content sources over which the search for content was performed; and
performing at least one of:
providing in a third portion of the UI one or more of the ranked results that corresponds to each content source in the list of content sources; or
providing in the third portion of the UI one or more user-selectable options configured to initiate an action associated with an associated result of the one or more of the ranked results.

16. The computer-readable storage medium of claim 15, wherein the one or more of the ranked results includes related description information displayed in the third portion of the UI.

17. The computer-readable storage medium of claim 15, wherein one or more user-selectable options are configured to initiate an action comprising at least one of:
providing, to a user, content for the associated result;
recording the content for the associated result;
providing, to the user, additional content related to the content for the associated result; or
providing, to the user, additional information related to the content for the associated result.

18. The computer-readable storage medium of claim 15, wherein the method comprises:
receiving an indication of a user selection for one content source of the list of content sources in the second portion of the UI;
removing from the third portion of the UI ranked results associated with content sources other than the one content source; and
providing in the third portion of the UI one or more of the ranked results that corresponds to the selected one content source in the list of content sources.

19. The computer-readable storage medium of claim 15, wherein the computing device is an HDMI switch, and the method further comprises:
receiving a selection made by a user of a result of the ranked results; and
automatically configuring a connection by the HDMI switch to provide the content for display of the user.

20. The computer-readable storage medium of claim 15, wherein the one or more of the ranked results are provided to the third portion of the UI for display to a user in an order corresponding to respective rankings of the one or more of the ranked results.
